(19) United States
(12) Patent Application Publication
(10) Pub. No.: US 2026/0264471 A1
(43) Pub. Date: Sep. 10, 2026

(54) AIR CONDITIONER FOR VEHICLE

(71) Applicant: HANON SYSTEMS, Daejeon (KR)

(72) Inventors: Hwan Kyu CHO, Daejeon (KR); JaeWoo KO, Daejeon (KR); KI MAN JEON, Daejeon (KR)

(21) Appl. No.: 19/559,214

(22) Filed: Mar. 6, 2026

(30) Foreign Application Priority Data
Mar. 6, 2025 (KR) 10-2025-0029286
Jan. 12, 2026 (KR) 10-2026-0005253

(51) Int. Cl. B60H 1/00

(52) U.S. Cl. CPC B60H 1/00028; B60H 1/00064; B60H 2001/00114; B60H 2001/00185

(57) ABSTRACT

An air conditioner for a vehicle according to one embodiment includes an air conditioning case in which an air inflow port for introducing air and air discharge ports for discharging air into the interior are formed and an air passage is formed therein; a cooling heat exchanger and a heating heat exchanger sequentially provided in the air passage of the air conditioning case in an air flow direction, wherein the air discharge ports include a defrost vent, a face vent, a floor vent for discharging air to front seats of the vehicle, and a rear air discharge port for discharging air to rear seats of the vehicle, wherein an auxiliary blower and an air suction port through which air flows into the auxiliary blower are provided between the cooling heat exchanger and the heating heat exchanger and the rear air discharge port.

### CROSS REFERENCE TO RELATED APPLICATION

The present application claims priority to Korean Patent Application No. 10-2025-0029286, filed on Mar. 06, 2025, and Korean Patent Application No. 10-2026-0005253, filed on Jan. 12, 2026, the entire contents of which are incorporated here for all purposes by this reference.

### BACKGROUND OF THE INVENTION

### Field of the Invention

The present invention relates to an air conditioner for a vehicle, and more specifically, to an air conditioner for a vehicle in which a console blower for blowing conditioned air to rear seats of the vehicle is disposed at a lower end of a distribution module.

### Background Art

In general, an air conditioner for a vehicle is a vehicle interior part that is installed for the purpose of cooling or heating the interior of a vehicle in the summer or winter season, or removing frost from the windshield during rainy or winter season, thereby enabling a driver to secure front and rear view. The air conditioner is usually equipped with both a heating system and a cooling system at the same time, and selectively introduces outside air or inside air, heats or cools the air, and then blows the air into the vehicle interior, thereby cooling, heating, or ventilating the vehicle interior.

Korean Patent No. 1484718 (published on Jan. 14, 2015), which was previously filed, discloses a vehicle air conditioner that adjusts the air volume for rear seats by controlling the positions of a rear temperature door, a rear auxiliary temperature door, and a rear on-off door. Referring to FIG. 1, the air conditioner for a vehicle includes an air conditioning case 10, an evaporator 20 and a heater core 30, and a front temperature door 51 and a front mode door.

The air conditioning case 10 includes an air inflow port 11 and air discharge ports, and an air passage is formed therein. A blower device is connected to the air inflow port 11 side, and inside air or outside air is selectively introduced into the air passage inside the air conditioning case 10. The air discharge ports include a defrost vent 12, a front face vent 13, a front floor vent 14, a rear face vent 15, and a rear floor vent 16. The air passage inside the air conditioning case 10 includes a front cooling passage P1, a heating passage P2, and a rear cooling passage P3.

The evaporator 20 is a cooling heat exchanger and cools the air passing through it, and the heater core 30 is a heating heat exchanger and heats the air passing through it. The heater core 30 is disposed in the heating passage P2 downstream of the evaporator 20 in the air flow direction. An electric heater 40 such as a PTC heater may be further provided in the heating passage P2. The front temperature door 51 is disposed between the evaporator 20 and the heater core 30 to adjust the opening degree of the heating passage P2 passing through the heater core 30 and the cooling passages P1 and P3 bypassing the heater core 30. In addition, the front mode door includes a defrost door 53, a vent door 54, and a floor door 55.

The rear air passage consists of a rear cooling passage P3 where air passing through the evaporator 20 bypasses the heater core 30, and a heating passage where air passes through the heater core 30. This heating passage for the rear air passage is used together with the heating passage P2 for the front air passage. That is, a portion of the air flowing through the heating passage P2 after passing through the heater core 30 moves upward and is discharged to at least one of the defrost vent 12, the front face vent 13, and the front floor vent 14, and another portion of the air moves downward and is discharged to at least one of the rear face vent 15 and the rear floor vent 16. A rear mode door 58 for adjusting the opening degree of the rear face vent 15 and the rear floor vent 16 is provided in the rear air passage.

A rear temperature door 52, a rear auxiliary temperature door 56, and a rear on-off door 57 are provided in the air conditioning case 10. The rear temperature door 52 is provided between the evaporator 20 and the heater core 30 to adjust the opening degree of the passage flowing to the heating passage P2 and the passage flowing to the rear cooling passage P3. The rear auxiliary temperature door 56 is disposed downstream of the heater core 30 in the air flow direction to adjust the opening degree of the passage flowing to the rear air discharge port. The rear on-off door 57 adjusts the opening degree of the rear cooling passage P3.

The conventional air conditioner for a vehicle may further provide a separate console blower at the rear air discharge port for smooth blowing toward the rear seats of the vehicle. In this case, when the cockpit module including the distribution module of the air conditioner is mounted in the vehicle interior, the lowermost portion where the console blower is installed is positioned on the path of the lower panel on the vehicle side, which makes automation of assembly impossible or difficult.

### SUMMARY OF THE INVENTION

It is an aspect of the present disclosure to provide an air conditioner for a vehicle which can raise the position of the lowermost portion upward to avoid interference with the vehicle-side panel during indoor installation and reduce the inlet passage resistance of the console-side passage.

Additional aspects of the disclosure will be set forth in part in the description which follows and, in part, will be obvious from the description, or may be learned by practice of the disclosure

In accordance with one aspect of the present disclosure, an air conditioner for a vehicle according to the present invention comprises: an air conditioning case including an air inflow port for introducing air, air discharge ports for discharging air into the interior of the vehicle, and an air passage formed therein; a cooling heat exchanger and a heating heat exchanger disposed in the air passage of the air conditioning case; wherein the air discharge ports include a defrost vent, a face vent, and a floor vent for discharging air to front seats of the vehicle, and a rear air discharge port for discharging air to rear seats of the vehicle; and wherein an auxiliary blower and an air suction port through which air is introduced into the auxiliary blower are provided between the cooling heat exchanger and the heating heat exchanger and the rear air discharge port, wherein the air suction port and the auxiliary blower are sequentially disposed in parallel in the front-rear direction of the vehicle, and a scroll portion of the auxiliary blower is disposed between the auxiliary blower and the air suction port.

The air suction port of the auxiliary blower is disposed on a front surface of a scroll case in a direction parallel to the air flow direction.

The air suction port of the auxiliary blower is positioned eccentrically upward from a rotation axis of a blower motor.

The scroll case includes a scroll expanded portion in which a passage width increases as it goes downstream in the air flow direction.

The scroll expanded portion is disposed within the air suction port.

A starting point of the scroll expanded portion is disposed within the air suction port.

The scroll expanded portion includes a first inclined portion formed upstream in the air flow direction and a second inclined portion formed downstream of the first inclined portion.

An expansion angle of the first inclined portion and an expansion angle of the second inclined portion are configured to be different from each other.

The expansion angle of the second inclined portion is larger than the expansion angle of the first inclined portion.

The first inclined portion is configured such that more of it is positioned within the air suction port than the second inclined portion.

A starting point of the second inclined portion where the first inclined portion and the second inclined portion are distinguished is disposed outside an opening of the air suction port.

A diameter of the air suction port of the auxiliary blower is smaller than an outer diameter of the scroll case.

The scroll case includes an inlet ring at an air suction port, and a duct height of the scroll case covering the inlet ring is formed to decrease as it goes downstream from the air suction port in the air flow direction.

An on-off door for opening and closing the air passage through rotation is further provided upstream of the air suction port in the air flow direction, and a rotation axis of the on-off door is formed on a bottom surface of a lowermost end portion of the air conditioning case.

The first inclined portion is configured to be disposed 50% to 80% within the air suction port.

The scroll case is expanded such that a rotation direction of a blower wheel of the auxiliary blower is configured to be counterclockwise.

The air conditioner for a vehicle according to the present disclosure can reduce passage resistance on the rear air discharge port (console) side, improve assemblability, and increase the air volume of the rear air discharge port by forming a separate auxiliary blower with a plurality of two or more scroll expanded portions and arranging the point just before the inclined portions meet not to be disposed on the passage of the air suction port, thereby obtaining an effect of reducing energy consumption. In addition, in order to obtain maximum blowing performance within a limited package, the scroll shape and arrangement of the auxiliary blower, the angle, and the position of the on-off door are optimized.

### BRIEF DESCRIPTION OF THE DRAWINGS

FIG. 1 is a side cross-sectional view illustrating a conventional air conditioner for a vehicle;

FIG. 2 is a perspective view illustrating an air conditioner for a vehicle according to an embodiment of the present disclosure;

FIGS. 3 and 4 are side cross-sectional views illustrating an air conditioner for a vehicle according to an embodiment of the present disclosure;

FIG. 5 is a perspective view illustrating an auxiliary blower of an air conditioner for a vehicle according to an embodiment of the present disclosure;

FIG. 6 is a side cross-sectional view illustrating an auxiliary blower of an air conditioner for a vehicle according to an embodiment of the present disclosure;

FIG. 7 is a perspective view illustrating an enlarged portion of an auxiliary blower according to an embodiment of the present disclosure;

FIG. 8 is a front view illustrating an auxiliary blower of an air conditioner for a vehicle according to an embodiment of the present disclosure;

FIG. 9 is a front view illustrating an enlarged portion of a scroll case and an air suction port according to an embodiment of the present disclosure;

FIG. 10 illustrates an air flow of an auxiliary blower of an air conditioner for a vehicle according to an embodiment of the present disclosure;

FIG. 11 is a cross-sectional view illustrating a scroll case around an inlet ring according to an embodiment of the present disclosure; and

FIG. 12 is a front view illustrating an enlarged portion of a scroll case and an air suction port according to another embodiment of the present disclosure.

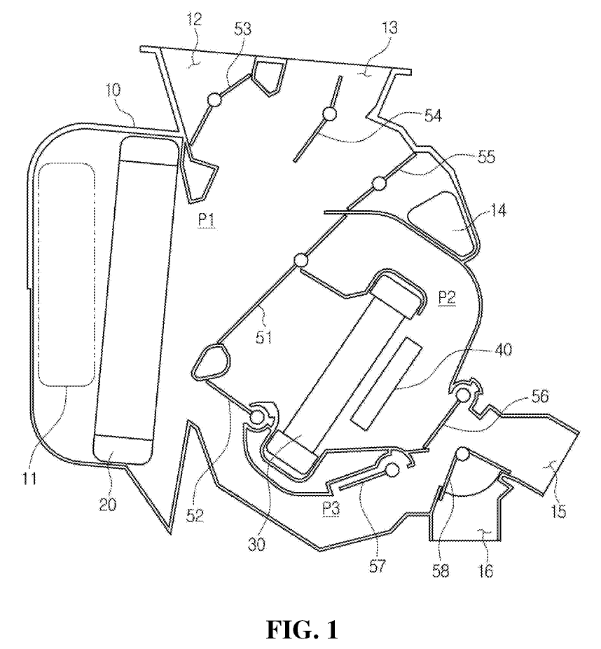

### DETAILED DESCRIPTION OF THE PREFERRED EMBODIMENT

Hereinafter, the technical configuration of an air conditioner for a vehicle will be described in detail with reference to the accompanying drawings.

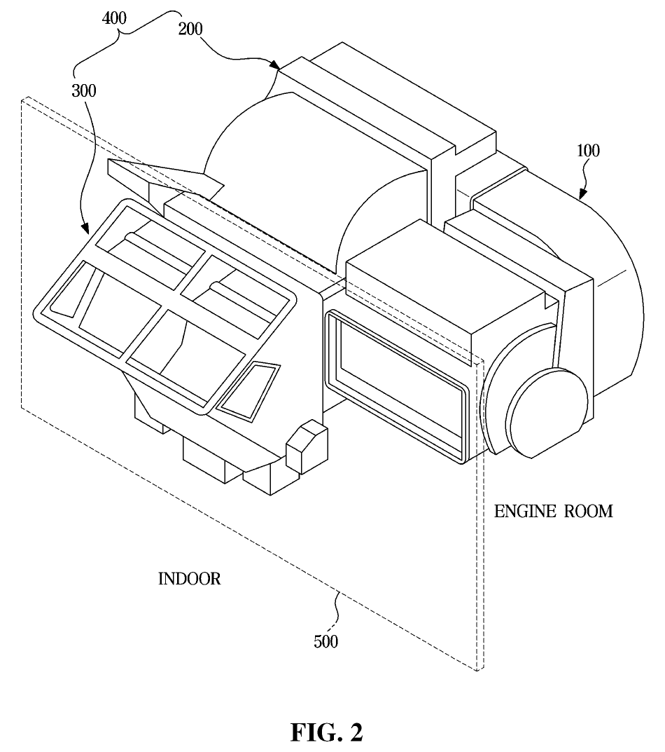

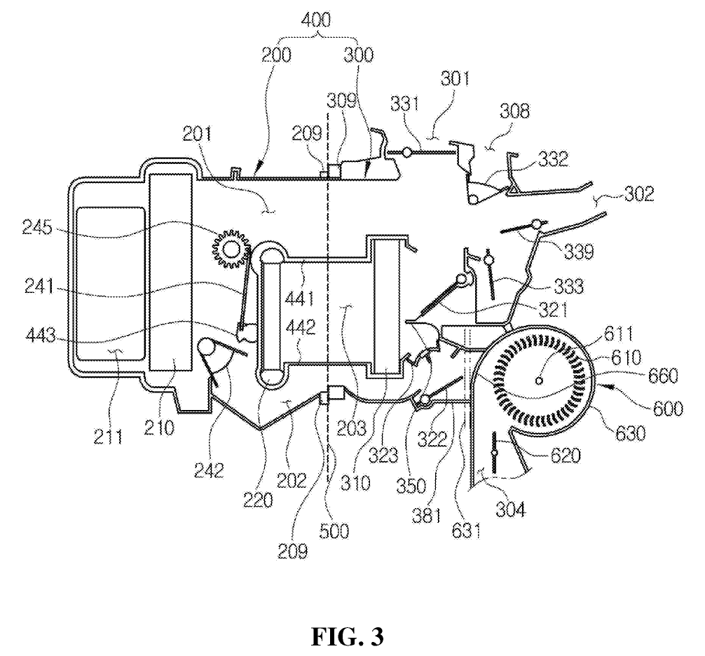

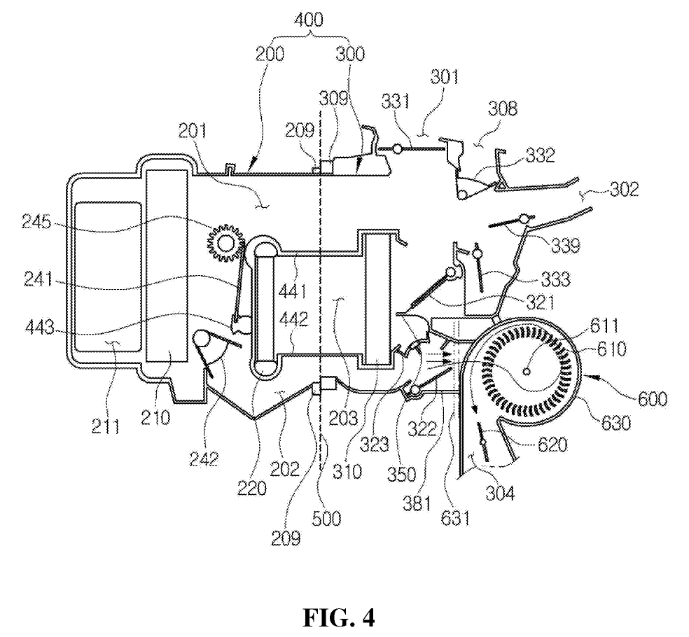

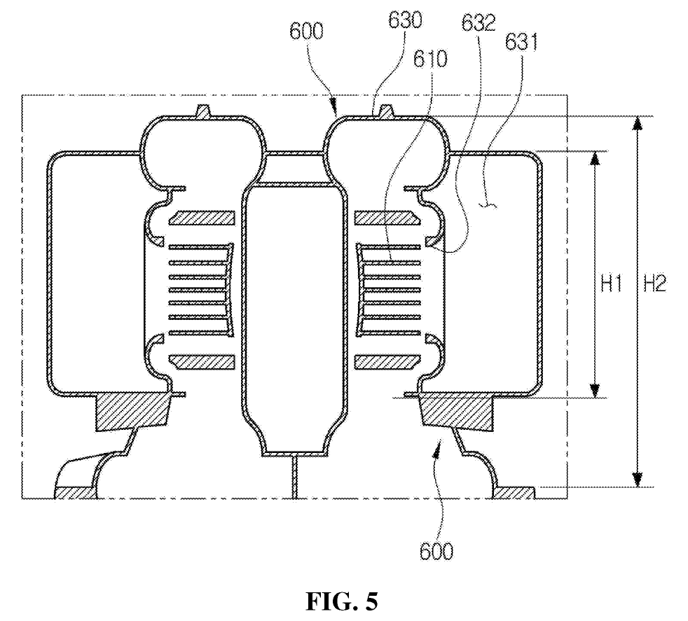

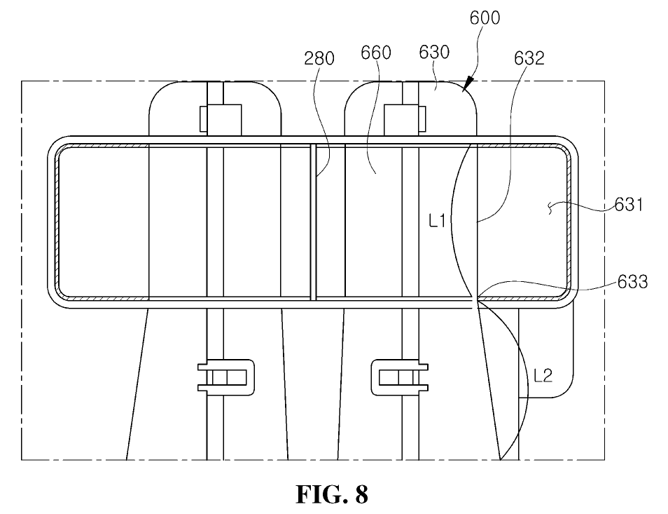

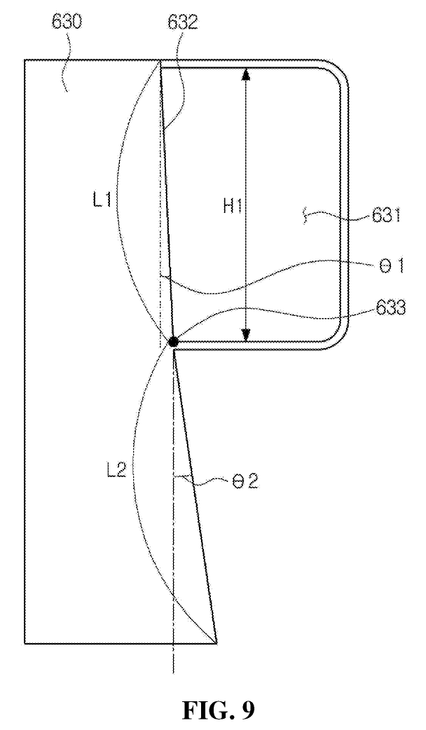

Referring to FIGS. 2 to 11, an air conditioner for a vehicle according to an embodiment of the present disclosure is an air conditioner using a heat pump system installed in an electric vehicle, and includes a blower unit 100 and an air conditioning unit. The air conditioning unit includes an air conditioning case 400, a cooling heat exchanger, and a heating heat exchanger.

The air conditioning case 400 is formed with an air inflow port 211 for introducing air and air discharge ports for discharging air into the interior, and an air passage is formed therein. The air conditioning case 400 includes a heat exchanger module 200 disposed on the vehicle engine room side and a distribution module 300 disposed on the vehicle interior side.

The distribution module 300 and the heat exchanger module 200 are coupled from both sides in the front-rear direction of the vehicle with respect to a dashboard panel 500 to form the air conditioning case 400. The dashboard panel 500 is formed with through holes for fastening the distribution module 300 and the heat exchanger module 200 by penetrating them in the front-rear direction of the vehicle. A fastening portion 209 is formed at an end of the distribution module 300 to be coupled with the heat exchanger module 200, and a fastening portion 309 corresponding to the fastening portion 209 of the heat exchanger module 200 is also formed on the distribution module 300.

The cooling heat exchanger and the heating heat exchanger are sequentially provided in the air passage of the air conditioning case 400 in the air flow direction and exchange heat with the air passing through them. The cooling heat exchanger is composed of an evaporator 210 that exchanges heat between refrigerant and air to cool the air. The heating heat exchanger is composed of an indoor heat exchanger 220. The indoor heat exchanger 220 is disposed downstream of the evaporator 210 in the air flow direction.

That is, a compressor, the indoor heat exchanger 220, an outdoor heat exchanger, an expansion valve, and the evaporator 210 are sequentially installed in a refrigerant line. In addition, the indoor heat exchanger 220 heats the air by dissipating heat by exchanging heat between the high-temperature and high-pressure refrigerant discharged from the compressor and the air in the air conditioning case 400, and the refrigerant throttled in the expansion valve cools the air by exchanging heat with the air in the evaporator 210.

Meanwhile, an electric heater 310 is further provided in the distribution module 300. The electric heater 310 is disposed downstream of the indoor heat exchanger 220 in the air flow direction. The electric heater 310 is installed at a similar height in the vertical direction on the rear side of the indoor heat exchanger 220, and the indoor heat exchanger 220 and the electric heater 310 are arranged side by side in the vertical direction. In addition, the electric heater 310 is composed of a PTC heater (Positive Temperature Coefficient Heater) and serves as an auxiliary heating heat exchanger that generates heat by applying power to heat the air passing through it.

The air passage of the air conditioning case 400 is divided into upper, lower, left, and right passages to form 4 zones. In addition, the air conditioner for a vehicle is configured to independently control air conditioning in four different areas of the vehicle interior through the air passage forming the four zones. That is, the air conditioner for a vehicle enables independent air conditioning for four zones: front driver's seat, front passenger seat, rear left (behind driver's seat), and rear right (behind passenger seat). As a result, independent air conditioning is possible in all areas of the vehicle interior, thereby improving the degree of freedom of air conditioning and increasing passenger satisfaction.

In this case, the air conditioner for a vehicle is configured to independently control temperature, mode, and air volume in four different areas (4-Zone) of the vehicle interior through the air passage forming the four zones. That is, the vehicle air conditioner with a 3-zone air conditioning control method can control temperature, mode, and air volume for the left and right (driver's seat and passenger seat) of the front seats of the vehicle, but cannot independently control the left and right of the rear seats, and can only control the temperature for the entire rear seats. The air conditioner for a vehicle according to an embodiment of the present disclosure is configured with a 4-zone air conditioning control method to provide more detailed and precise air conditioning control of the left and right rear seat areas of the vehicle as well as the front seats of the vehicle, thereby further increasing passenger satisfaction.

The air passage of the air conditioning case 400 includes an upper passage and a lower passage. The upper passage is further divided into a left upper passage and a right upper passage, and the lower passage is further divided into a left lower passage and a right lower passage. The air passage of the air conditioning case 400 is divided into left and right by a separator 280 provided at a central portion in the vehicle width direction. In addition, the air passage is divided into an upper passage and a lower passage based on a support portion 443 formed at a substantially central portion in the vertical direction.

The left upper passage discharges air to one side (left side) in the width direction of the front seats of the vehicle, and the right upper passage discharges air to the other side (right side) in the width direction of the front seats of the vehicle. The left lower passage discharges air to one side (left side) in the width direction of the rear seats of the vehicle, and the right lower passage discharges air to the other side (right side) in the width direction of the rear seats of the vehicle. In this way, the air passage of the air conditioning case 400 is divided into four passages.

Meanwhile, the indoor heat exchanger 220 and the electric heater 310 are disposed at a central portion in the vertical direction. In addition, the air passage of the air conditioning case 400 forms a warm air passage 203 at a central portion in the vertical direction, and cold air passages 201 and 202 are formed above and below the warm air passage 203, respectively. More specifically, the upper passage consists of an upper cold air passage 201 and an upper warm air passage, and the lower passage consists of a lower cold air passage 202 and a lower warm air passage.

That is, the upper passage is divided in the vertical direction based on an upper partition wall 441 into an upper cold air passage 201 and an upper warm air passage, and the lower passage is divided in the vertical direction based on a lower partition wall 442 into a lower warm air passage and a lower cold air passage 202. As a result, the upper cold air passage 201, the warm air passage 203, and the lower cold air passage 202 are sequentially formed in the air passage of the air conditioning case 400 from the upper direction to the lower direction. The upper partition wall 441 and the lower partition wall 442 support both sides of the heating heat exchanger in the vertical direction. An upper cold air passage 201 is formed above the upper partition wall 441, and a lower cold air passage 202 is formed below the lower partition wall 442.

That is, a warm air passage 203 is formed between the upper partition wall 441 and the lower partition wall 442, and the upper partition wall 441 supports the upper end of the indoor heat exchanger 220 and the electric heater 310, and the lower partition wall 442 supports the lower end of the indoor heat exchanger 220 and the electric heater 310. In addition, the warm air passage 203 between the indoor heat exchanger 220 and the electric heater 310 is not divided into upper and lower portions and forms one space.

Meanwhile, a main temperature door is provided between the evaporator 210 and the indoor heat exchanger 220, and an auxiliary temperature door is provided downstream of the indoor heat exchanger 220 in the air flow direction. The main temperature door and the auxiliary temperature door control the air temperature by adjusting the amount of cold or warm air. In addition, the main temperature door consists of a front main temperature door 241 and a rear main temperature door 242, and the auxiliary temperature door consists of a front auxiliary temperature door 321 and a rear auxiliary temperature door 323.

The front main temperature door 241 is disposed between the evaporator 210 and the indoor heat exchanger 220 to adjust the opening degree between the upper cold air passage 201 and the upper warm air passage, and the rear main temperature door 242 is disposed between the evaporator 210 and the indoor heat exchanger 220 to adjust the opening degree between the lower cold air passage 202 and the lower warm air passage.

The front auxiliary temperature door 321 is disposed downstream of the electric heater 310 in the air flow direction to control the air temperature discharged to the front seats of the vehicle, and the rear auxiliary temperature door 323 is disposed downstream of the electric heater 310 in the air flow direction to control the air temperature discharged to the rear seats. In addition, an on-off door 322 for controlling the amount of air discharged to the rear seats is further provided downstream of the rear auxiliary temperature door 323 in the air flow direction.

The front auxiliary temperature door 321 controls the amount of air passing through the indoor heat exchanger 220 and the electric heater 310 and heading to the front seat discharge port by rotating operation. The rear auxiliary temperature door 323 controls the amount of air passing through the indoor heat exchanger 220 and the electric heater 310 and heading to the rear seat discharge port and the amount of air bypassing the indoor heat exchanger 220 and the electric heater 310 and heading to the rear seat discharge port in the lower cold air passage 202 by rotating operation. That is, the front auxiliary temperature door 321 has a structure in which one end of a plate is rotated around a pivot axis, and completely closes the warm air passage (upper warm air passage) when rotated clockwise to the maximum, and completely opens the warm air passage (upper warm air passage) when rotated counterclockwise to the maximum.

The air discharge ports of the air conditioning case 400 consist of a front seat discharge port and a rear seat discharge port. The front seat discharge port consists of a defrost vent 301, an indirect vent 302, a face vent 308, and a floor vent 303, and the rear seat discharge port consists of a console vent and a rear seat floor vent. The air conditioning case 400 is provided with a plurality of mode doors. The mode doors consist of a defrost door 331 for adjusting the opening degree of the defrost vent 301, a vent door 332 for adjusting the opening degree of the indirect vent 302 and the face vent 308, a front floor door 333 for adjusting the opening degree of the floor vent 303, and a rear seat door for adjusting the opening degree of the console vent and the rear seat floor vent.

Among the air conditioning case 400, the air inflow port 211, the evaporator 210, the indoor heat exchanger 220, the front main temperature door 241, and the rear main temperature door 242 are disposed in the heat exchanger module 200 installed on the engine room side with respect to the dashboard panel 500. In addition, among the air conditioning case 400, the electric heater 310, the front auxiliary temperature door 321 and the rear auxiliary temperature door 323, the on-off door 322, the air discharge ports, and the mode doors are disposed in the distribution module 300 installed on the vehicle interior side with respect to the dashboard panel 500.

A separation partition wall 350 is provided in the air conditioning case 400. The separation partition wall 350 is formed downstream of the heating heat exchanger in the air flow direction. The separation partition wall 350 divides the air passage in the air conditioning case 400 into an upper passage heading to the front seats of the vehicle and a lower passage heading to the rear seats. The separation partition wall 350 extends substantially horizontally toward the rear from the rear end of the electric heater 310. The air that has passed through the electric heater 310 is separated into the upper passage and the lower passage by the separation partition wall 350, and the air in the upper passage is discharged to the front seat discharge port and the air in the lower passage is discharged to the rear air discharge port 304.

Meanwhile, the air conditioner for a vehicle according to an embodiment of the present disclosure includes an auxiliary blower 600. The auxiliary blower 600 is provided upstream of the rear air discharge port 304 for discharging air to the rear seats of the vehicle. The auxiliary blower 600 is connected upstream of the rear air discharge port 304 in the air flow direction to help smoothly blow air to the rear seats of the vehicle. In addition, an extension duct 381 extends in the horizontal direction in the air passage heading to the rear air discharge port 304. The auxiliary blower 600 is connected to the air conditioning case 400 by being coupled with the extension duct 381.

In particular, a scroll expanded portion of the auxiliary blower 600 is disposed below an air suction port 631. The auxiliary blower 600 includes a scroll case 630. A blower wheel 610 that is coupled to a rotation axis 611 of a blower motor and rotates is provided in the scroll case 630. A rear air volume door 620 for controlling the amount of air flowing to the rear seats is provided downstream of the blower wheel 610 in the air flow direction. In addition, the air suction port 631 of the auxiliary blower 600 is disposed on a front surface of the scroll case 630 in a direction parallel to the air flow direction.

That is, the air suction port 631 and the auxiliary blower 600 are sequentially disposed in parallel in the front-rear direction of the vehicle. In addition, a scroll portion 660 of the auxiliary blower 600 is disposed between the auxiliary blower 600 and the air suction port 631. The rear air discharge port 304 is formed downstream of the rear air volume control door 620, and the auxiliary blower 600 is provided upstream of the rear air volume control door 620.

The air suction port 631 is formed to be open on the front surface of the scroll case 630 of the auxiliary blower 600 and is coupled to the extension duct 381 of the air conditioning case 400. The air suction port 631 has an opening with a substantially rectangular cross-sectional shape, and the separator 280 is disposed at the center in the vehicle width direction. In this case, the air suction port 631 of the auxiliary blower 600 is positioned eccentrically upward from the rotation axis 611 of the blower motor.

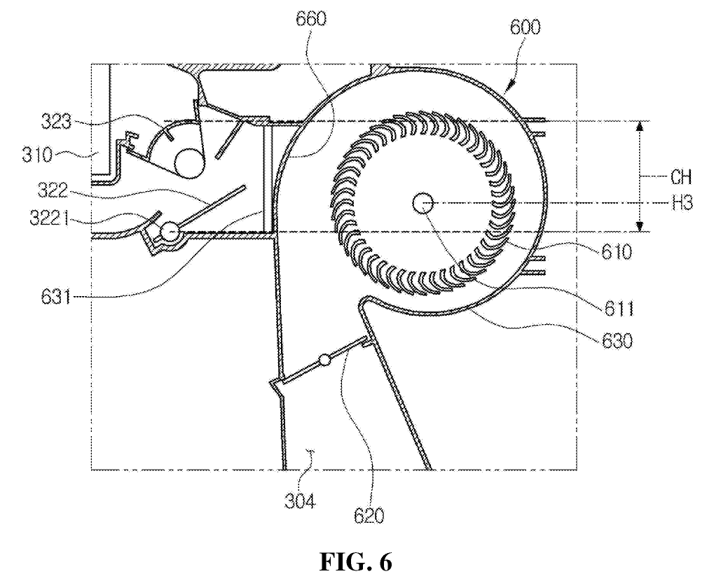

That is, as shown in FIG. 6, a height CH at the center in the vertical direction of the air suction port 631 is formed higher than a height H3 of the rotation axis 611 of the blower wheel 610. An on-off door 322 provided upstream of the air suction port 631 in the air flow direction to open and close the air passage is formed in the air conditioning case 400. In this case, a rotation axis 3221 of the on-off door 322 is formed on the bottom surface of the lowermost end portion of the air conditioning case 400.

Through such a configuration, the position of the lowermost end portion of the air conditioner can be raised to avoid interference with the vehicle-side panel when mounted in the vehicle interior. That is, the air discharged from the air conditioning case 400 flows into the auxiliary blower 600 side through the air suction port 631. At this time, since the position of the air suction port 631 is eccentrically disposed upward from the center of the blower wheel 610, it does not overlap with the scroll expanded portion as much as possible.

The scroll case 630 includes a scroll expanded portion in which a passage width increases as it goes downstream in the air flow direction. The scroll expanded portion is disposed within the air suction port 631. That is, a starting point of the scroll expanded portion is disposed within the air suction port 631. More specifically, the scroll expanded portion includes a first inclined portion L1 and a second inclined portion L2. The first inclined portion L1 is a point where expansion of the scroll starts and is formed upstream in the air flow direction. The second inclined portion L2 is formed downstream of the first inclined portion L1.

An expansion angle θ1 of the first inclined portion L1 and an expansion angle θ2 of the second inclined portion L2 are configured to be different from each other. That is, the expansion angle θ2 of the second inclined portion L2 is formed larger than the expansion angle θ1 of the first inclined portion L1. The auxiliary blower 600 necessarily needs a scroll expanded portion in which the area of the passage gradually increases in order to improve blowing performance. However, if the scroll expanded portion is unconditionally formed large, the blowing performance is improved, but the air suction port 631 is covered by the scroll expanded portion, so that the area of the air suction port 631 is reduced, and thus air cannot smoothly flow into the auxiliary blower 600.

In order to solve this problem, the present disclosure configures the scroll expanded portion with a first inclined portion L1 and a second inclined portion L2, and configures the first inclined portion L1 such that more of it is positioned within the air suction port 631 than the second inclined portion L2. In addition, a starting point 633 of the second inclined portion L2 where the first inclined portion L1 and the second inclined portion L2 are distinguished is disposed not at the opening of the air suction port 631 but at a point outside the opening of the air suction port 631. That is, the starting point 633 of the second inclined portion L2 is disposed outside the opening of the air suction port 631.

In addition, a diameter H1 of the air suction port 631 of the auxiliary blower 600 is made smaller than an outer diameter H2 of the scroll case 630. And, the first inclined portion L1 is configured to be disposed 50% to 80% within the air suction port 631. More preferably, the first inclined portion L1 is disposed 75% or more within the air suction port 631. If the first inclined portion L1 is less than 50% within the air suction port 631, the second inclined portion L2 with a large inclination is located a lot within the air suction port 631, so the area of the passage is reduced and the passage resistance becomes large. If the first inclined portion L1 exceeds 80% within the air suction port 631, the first inclined portion L1 with a small inclination occupies a large part of the scroll case 630, so the scroll expansion effect is reduced, and thus blowing performance cannot be improved.

In this way, by forming a separate auxiliary blower 600 with a plurality of two or more scroll expanded portions and arranging the point just before the inclined portions meet not to be disposed on the passage of the air suction port 631, and making the diameter H1 of the air suction port 631 smaller than the outer diameter H2 of the scroll case 630, it is possible to reduce passage resistance on the rear air discharge port (console) side, improve assemblability, and increase the air volume of the rear air discharge port 304, thereby obtaining an effect of reducing energy consumption.

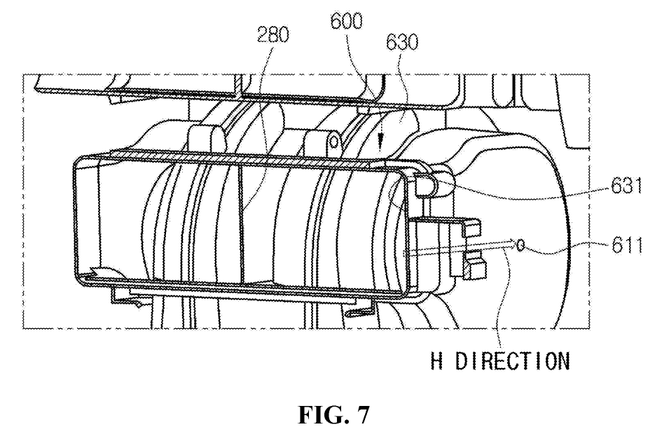

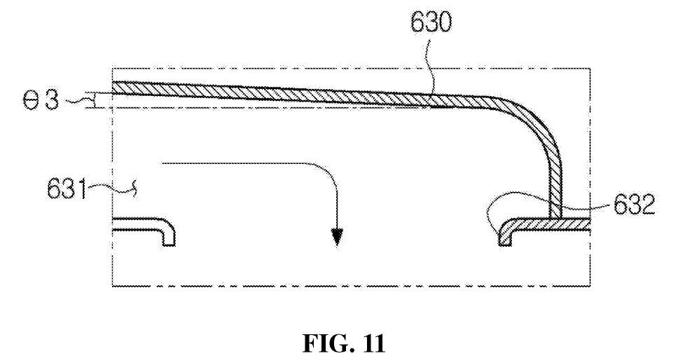

Meanwhile, as shown in FIG. 11, the scroll case 630 includes an inlet ring 632 at an air suction port. A duct height of the scroll case 630 covering the inlet ring 632 is formed to decrease as it goes downstream from the air suction port 631 in the air flow direction. That is, the duct of the scroll case 630 covering the inlet ring 632 is formed to be inclined at a certain angle θ3 with respect to the horizontal direction, so that the passage width becomes narrower as it goes downstream from the air suction port 631 in the air flow direction (H direction in FIG. 7). Through such a configuration, an effect of making the suction of air into the auxiliary blower 600 smoother can be obtained.

In addition, the scroll case 630 is expanded such that a rotation direction of the blower wheel 610 of the auxiliary blower 600 is configured to be counterclockwise. When the auxiliary blower 600 is disposed in the front-rear direction of the air conditioning case 400, by setting the rotation direction of the scroll to counterclockwise, the duct assembly direction of the final air conditioning case distribution module and the auxiliary blower 600 can be matched, and at the same time, the position of the lowermost end portion of the air conditioning case 400 can be positioned higher than before.

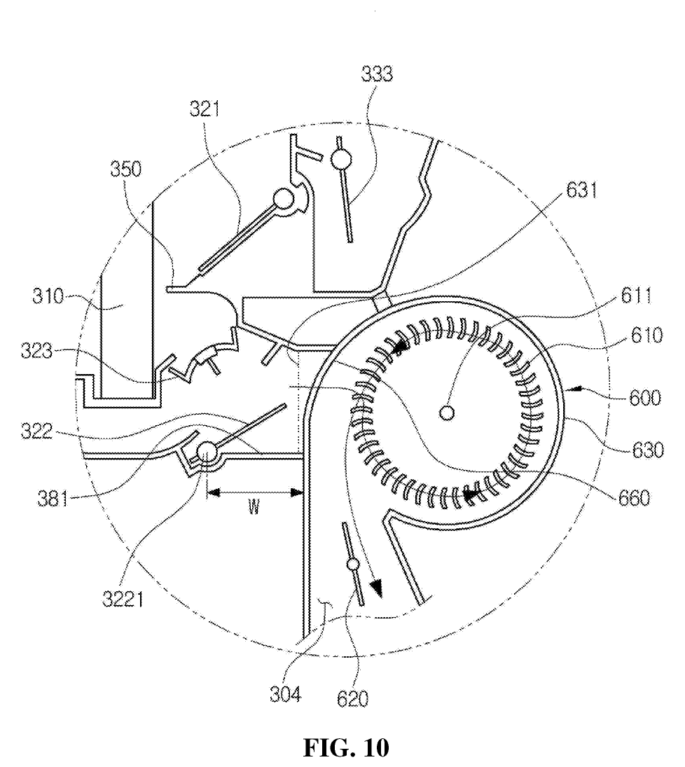

There is a limit to arranging the air conditioning case 400 in the vehicle width direction and the front-rear direction of the vehicle due to the support structure of the cowl cross bar of the vehicle in terms of package. In this case, in order to maximize the inlet passage area of the air suction port 631, the size of the on-off door 322 must be increased, but the size cannot be increased due to the package limitation in the front-rear direction of the vehicle (W direction in FIG. 10). Therefore, in the present disclosure, in order to obtain maximum blowing performance within a limited package, the scroll shape and arrangement of the auxiliary blower 600, the angle, and the position of the on-off door 322 are optimized.

First, the position of the on-off door 322 is such that a pivot rotation axis 3221 is disposed on the lower side so that the flow of the cold air passage and the warm air passage on the lower side of the air conditioning case 400 can be well guided, and the air suction port 631 has an expanded portion shape to fit the wheel size, and a diameter size of the air suction port 631 is formed smaller than an outer size of the scroll case 630, so that the air sucked through the air suction port 631 is configured not to flow in by turning outward.

In addition, in order for the auxiliary blower 600 to produce good blowing performance, the shape of the scroll expanded portion must be optimized. However, in the case of the auxiliary blower 600 unit mounted integrally with the air conditioner, the shape of the expanded portion and the shape of the passage have opposite effects. That is, when the scroll expanded portion is formed sufficiently large, the passage of the air suction port 631 is blocked, so performance deteriorates, and when the scroll expanded portion is minimized, the passage area of the air suction port 631 is secured, but the blowing performance of the auxiliary blower 600 itself deteriorates. In order to solve this problem, the scroll expanded portion is divided into a first inclined portion L1 and a second inclined portion L2, and the first inclined portion L1 is configured to occupy most of the passage area of the air suction port 631, thereby maximizing performance.

At least a portion of the scroll expanded portion may be disposed on a region corresponding to the air suction port 631.

For example, only the first inclined portion L1 of the scroll expanded portion may be disposed on a region corresponding to the air suction port 631.

The second expanded portion L2 may be disposed outside a region corresponding to the air suction port 631 in the height direction. For example, the second expanded portion L2 may be disposed lower than a region corresponding to the air suction port 631 in the height direction so that only the first inclined portion L1 is disposed on the air suction port 631.

For example, at least a portion of the first inclined portion L1 and at least a portion of the second inclined portion L2 of the scroll expanded portion may be disposed on a region corresponding to the air suction port 631.

For example, the first inclined portion L1 of the scroll expanded portion may be disposed to have a larger area than the second inclined portion L2 on a region corresponding to the air suction port 631.

In addition, at least the portion of the scroll portion 660 is disposed between the air suction port 631 and the inlet ring 632, and at least one air inflow passage may be provided to supply air that has passed through the cooling heat exchanger or the heating heat exchanger to the auxiliary blower 600.

On the air suction port 631, at least the portion of the scroll portion 660 may be disposed at a center. For example, between the air suction port 631 and the inlet ring 632, at least the portion of the scroll portion 660 may be disposed at a center.

At least one air inflow passage may be formed in a space outside at least the portion of the scroll portion 660 between the air suction port 631 and the inlet ring 632.

For example, between the air suction port 631 and the inlet ring 632, at least one air inflow passage may be formed on one side or both sides of the scroll portion.

The scroll case 630 may guide the air introduced into the air suction port 631 to the inlet ring 632.

For example, the air flowed between the air suction port 631 and the inlet ring 632 through the air suction port 631 may be guided to the inlet ring 632 along an outer surface of the scroll case 630 positioned between the air suction port 631 and the inlet ring 632.

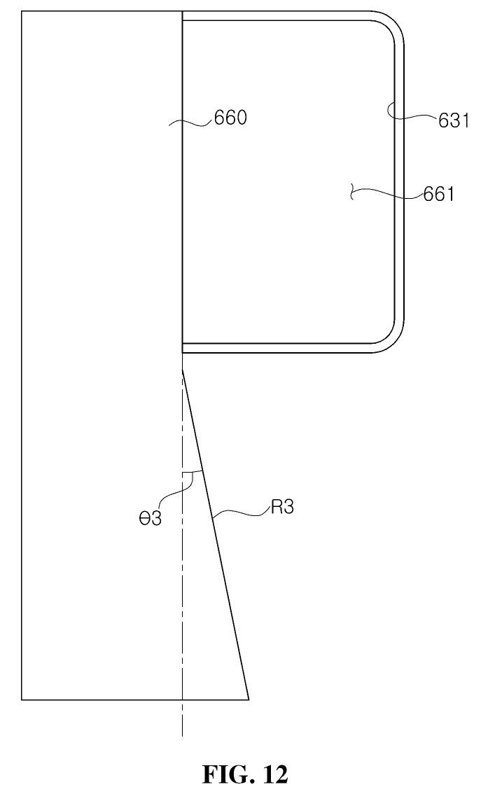

As shown in FIG. 12, at least a portion of the scroll portion 660 of the auxiliary blower 600 according to another embodiment of the present disclosure may be provided to extend linearly in a height direction on a region corresponding to the air suction port 631 in the height direction.

This is to maximize the amount of air that can be sucked at the air suction port 631.

Accordingly, the scroll expanded portion L3 extends downward from at least the portion of the scroll portion 660 at an expansion angle θ3 obliquely, and may be disposed outside a region corresponding to the air suction port 631 in the height direction.

Accordingly, an area in which at least one air inflow passage 661 can be formed between the air suction port 631 and the inlet ring 632 can be increased, so that the amount of air introduced into the auxiliary blower 600 can be increased.

A starting point at which expansion of the scroll expanded portion L3 starts may be disposed outside a region corresponding to the air suction port 631 in the height direction. For example, a starting point at which expansion of the scroll expanded portion L3 starts may be disposed outside the air suction port 631.

The scroll expanded portion L3 may have an increased area compared to at least a portion of the scroll portion 660 extending linearly by extending obliquely with an expansion angle θ3, and accordingly, the area of at least one air inflow passage 661 may be reduced and suction efficiency may be reduced.

The scroll expanded portion L3 of the auxiliary blower 600 according to another embodiment of the present disclosure can increase the suction efficiency of the auxiliary blower 600 by disposing it outside the air suction port 631 where suction does not occur. So far, the air conditioner for a vehicle according to the present disclosure has been described with reference to the embodiments shown in the drawings, but this is only illustrative, and those skilled in the art will understand that various modifications and equivalent other embodiments are possible therefrom. Therefore, the true technical protection scope should be determined by the technical spirit of the appended claims.

What is claimed is:

1. An air conditioner for a vehicle comprising:
an air conditioning case including an air inflow port for introducing air, air discharge ports for discharging air into the interior of the vehicle, and an air passage formed therein;
a cooling heat exchanger and a heating heat exchanger disposed in the air passage of the air conditioning case;
an auxiliary blower for blowing a portion of the air flowing to the air discharge ports;
wherein the air discharge ports include a plurality of front air discharge ports for discharging air to front seats of the vehicle and a rear air discharge port for discharging air to rear seats of the vehicle,
wherein the auxiliary blower is disposed between the cooling heat exchanger or the heating heat exchanger and the rear air discharge port, and
wherein the auxiliary blower includes a scroll case having an inlet and a scroll portion extending from the inlet, and an air suction port provided to allow air to flow into the scroll case, wherein at least a portion of the scroll portion is disposed between the air suction port and the inlet, and at least one air inflow passage is provided to supply air that has passed through the cooling heat exchanger or the heating heat exchanger to the auxiliary blower.

2. The air conditioner according to claim 1, wherein the portion of the scroll portion is disposed at a center between the air suction port and the inlet, and
wherein the at least one air inflow passage is formed on one side or both sides of the scroll portion between the air suction port and the inlet.

3. The air conditioner according to claim 2, wherein the scroll case guides the air introduced into the air suction port to the inlet.

4. The air conditioner according to claim 1, wherein a center of the air suction port in a height direction is positioned above a rotation axis of a blower motor of the auxiliary blower.

5. The air conditioner according to claim 1, wherein the portion of the scroll portion extends linearly in a height direction on a region corresponding to the air suction port in the height direction.

6. The air conditioner according to claim 5, wherein the scroll portion includes an expanded portion extending from the portion of the scroll portion and having an increased internal area of the scroll portion in an air flow direction, and
wherein the expanded portion is disposed outside a region corresponding to the air suction port in the height direction.

7. The air conditioner according to claim 1, wherein the scroll portion includes an expanded portion having an increased internal area of the scroll portion in an air flow direction, and
wherein at least a portion of the expanded portion is disposed on a region corresponding to the air suction port in a height direction.

8. The air conditioner according to claim 7, wherein the expanded portion includes a first expanded portion extending at a first inclination angle in an air flow direction, and a second expanded portion extending from the first expanded portion and extending at a second inclination angle greater than the first inclination angle.

9. The air conditioner according to claim 8, wherein the first expanded portion has a larger area than the second expanded portion on a region corresponding to the air suction port.

10. The air conditioner according to claim 8, wherein the second expanded portion is disposed outside a region corresponding to the air suction port in the height direction.

11. The air conditioner according to claim 1, wherein the air suction port is disposed upstream of the inlet in an air flow direction.

12. The air conditioner according to claim 1, wherein a diameter of the air suction port in a height direction is smaller than an outer diameter of the scroll case.

13. The air conditioner according to claim 1, wherein the scroll case includes a duct covering the inlet, and
wherein a width of the duct is formed to decrease in an air flow direction.

14. The air conditioner according to claim 1, further comprising an on-off door disposed upstream of the air suction port in an air flow direction and opening and closing the air passage through rotation,
wherein a rotation axis of the on-off door is formed on a bottom surface of a lower end portion of the air conditioning case.
